(19) United States
(12) Patent Application Publication
(10) Pub. No.: US 2026/0102723 A1
(43) Pub. Date: Apr. 16, 2026

(54) WATER PURIFIER

(71) Applicant: Guangdong Lizi Technology Co., Ltd., Foshan (CN)

(72) Inventors: Xing Zhan, Foshan (CN); Yining Duan, Foshan (CN); Jiawei Chen, Foshan (CN); Pingtao Chen, Foshan (CN); Wenbin Chen, Foshan (CN); Guoxiang Chen, Foshan (CN); Jianbo Huang, Foshan (CN); Yutai Huang, Foshan (CN); Xiaoping Chen, Foshan (CN)

(21) Appl. No.: 18/952,086

(22) Filed: Nov. 19, 2024

(30) Foreign Application Priority Data
Oct. 10, 2024 (CN) 202422454341.8

(51) Int. Cl. B01D 35/30

(52) U.S. Cl. CPC B01D 35/306; B01D 2201/301; B01D 2201/4015; B01D 2201/4076

(57) ABSTRACT

A water purifier is provided, including a main housing, a waterway board component, and a bracket component. A mounting opening is provided on one surface of the main housing, the waterway board component and the bracket component are inserted into the main housing from the mounting opening. At least two first and second reinforcing ribs are respectively arranged on the opposite first side wall and second side wall of the main housing. Both the first reinforcing ribs and the second reinforcing ribs extends into the main housing along the mounting opening. First limiting slots and second limiting slots are provided in two sides of the waterway board component or/and the bracket component, the first limiting slots are clamped to the first reinforcing ribs, and the second limiting slots are clamped to the second reinforcing ribs. The present disclosure has high structural stability, and provides a good user experience.

### CROSS REFERENCE TO RELATED APPLICATIONS

The present application claims the benefit of Chinese Patent Application No. 202422454341.8 filed on Oct. 10, 2024, the contents of which are incorporated herein by reference in their entirety.

### TECHNICAL FIELD

The present disclosure relates to the technical field of water purifiers, specifically to a water purifier.

### BACKGROUND

In existing water purifiers, waterway components and booster pump brackets are fixed inside the housing through screws or buckles, resulting in relatively poor connection reliability. Especially during long-term use, vibrations from the booster pump can easily cause the internal structure to loosen, resulting in abnormal noises during operation and a poor user experience.

### SUMMARY

In view of this, the present disclosure provides a water purifier. Through a cooperation of reinforcing ribs and limiting slots, two sides of a waterway board component and/or a bracket component are reliably connected to a main housing. Long term use is also less likely to produce abnormal noise, with high structural stability and excellent user experience.

The present disclosure provides a water purifier, including a main housing, a waterway board component, and a bracket component, a mounting opening is provided on one surface of the main housing, the waterway board component and the bracket component are inserted into the main housing from the mounting opening, at least two first reinforcing ribs and at least two second reinforcing ribs are respectively arranged on opposite first side wall and second side wall of the main housing, both the first reinforcing ribs and the second reinforcing ribs extend into the main housing along the mounting opening, first limiting slots and second limiting slots are provided in two sides of the waterway board component or/and the bracket component, the first limiting slots are clamped to the first reinforcing ribs, and the second limiting slots are clamped to the second reinforcing ribs.

Optionally, wherein the waterway board component closes the mounting opening, one surface of the waterway board component facing an inner cavity of the main housing is a waterway connection surface, one surface of the waterway board component facing away from the inner cavity of the main housing is an appearance surface exposed out of the mounting opening, the waterway connection surface is provided with a filter element plugging structure, one end of the first limiting slot and one end of the second limiting slot penetrate into the waterway connection surface, and the other end of the first limiting slot and the other end of the second limiting slot have a predetermined distance from the appearance surface.

Optionally, wherein the waterway board component comprises a first cover plate and a second cover plate, one surface of the first cover plate and one surface of the second cover plate are fixedly connected towards each other to form a waterway chamber, the other surface of the first cover plate is the waterway connection surface, and the other surface of the second cover plate is the appearance surface, the appearance surface is flush with an edge of the mounting opening of the main housing, the first limiting slot and the second limiting slot are provided in the first cover plate, and the first limiting slot and the second limiting slot penetrates to the waterway connection surface from a surface of the first cover plate connected to the second cover plate.

Optionally, wherein cross sections of both the first reinforcing rib and the second reinforcing rib are rectangle, dovetail shaped, L-shaped, or T-shaped, shapes of the cross sections of both the first limiting slot and the second limiting slot are matched with the shapes of the first reinforcing rib and the second reinforcing rib.

Optionally, wherein bayonet slots are provided in one end of the first reinforcing rib close to the mounting opening and one end of the second reinforcing rib close to the mounting opening, the bayonet slots are arranged close to an inner side wall of the main housing, the waterway board component is provided with convex blocks at the first limiting slot and the second limiting slot, and the convex blocks are inserted into the bayonet slots.

Optionally, wherein the bracket component is fixedly connected to the waterway board component;

and/or, a bottom of the bracket component is connected to a third side wall of the main housing, a third reinforcing rib is arranged on the third side wall of the main housing, the bracket component is provided with a plurality of convex ribs, the convex ribs are connected to the third reinforcing rib in a staggered manner, or, a limiting slot is formed between two convex ribs, and the third reinforcing rib is clamped in the limiting slot.

Optionally, wherein the bracket component is provided with a plurality of convex ribs, a third limiting slot is formed between two convex ribs, and/or, bayonet slots are provided in one end of the third limiting slot close to the mounting opening, the bayonet slots are arranged close to an inner side wall of the main housing, the waterway board component is provided with convex blocks at the third limiting slot, and the convex blocks are inserted into the bayonet slots.

Optionally, the waterway board integrated component according to claim 1, wherein a fourth limiting slot is provided in a top of the waterway board component, a fourth reinforcing rib is arranged on a fourth side wall of the main housing, the fourth reinforcing rib extends into the main housing along the mounting opening, and is clamped in the fourth limiting slot.

Optionally, wherein the main housing has a filter element mounting side, the filter element mounting side is provided with a filter element mounting hole for the filter element component to be inserted into a filter element plugging structure, a main lining plate is integrally arranged in the filter element mounting hole, and the main lining plate extends from an edge of the filter element mounting hole to a direction of the filter element plugging structure, there is a predetermined distance between the main lining plate and the filter element plugging structure;

below the filter element plugging structure, the waterway connection surface is fixedly connected to an auxiliary lining plate, one end of the auxiliary lining plate is fixed to the waterway connection surface, while the other end abuts against an edge of the main lining plate, lining plate limiting slots are provided in the two sides of the auxiliary lining plate, and the lining plate limiting slots sleeves the first reinforcing rib and the second reinforcing rib.

Optionally, wherein the auxiliary lining plate is cylindrical or semi-cylindrical, and a front end of the auxiliary lining plate is provided with a fitting portion for sticking to an outer circumference of an end of the main lining plate.

The present disclosure provides a water purifier, at least two first reinforcing ribs and at least two second reinforcing ribs are respectively arranged on opposite first side wall and second side wall of the main housing, both the first reinforcing ribs and the second reinforcing ribs extend into the main housing along the mounting opening, first limiting slots and second limiting slots are provided in two sides of the waterway board component or/and the bracket component, the first limiting slots are clamped to the first reinforcing ribs, and the second limiting slots are clamped to the second reinforcing ribs. Through the cooperation of the reinforcing ribs and the limiting slots, the two sides of the waterway board component and/or the bracket component are reliably connected to the main housing. Long term use is also less likely to produce abnormal noise, with high structural stability and excellent user experience.

### BRIEF DESCRIPTION OF THE DRAWINGS

To describe the technical solutions in this embodiments of the present disclosure more clearly, the following briefly describes the accompanying drawings required for describing the implementations. Apparently, the accompanying drawings in the following description show some implementations of the present disclosure, and persons skilled in the art may still derive other drawings from these accompanying drawings without creative labors.

FIG. 1 illustrates a three-dimensional assembly diagram of a water purifier provided by an embodiment of the present disclosure, viewed from a first angle;

FIG. 2 illustrates a three-dimensional assembly diagram of a water purifier provided by an embodiment of the present disclosure, viewed from a second angle;

FIG. 3 illustrates a three-dimensional assembly diagram of a waterway board component and a bracket component provided by an embodiment of the present disclosure, viewed from a first angle;

FIG. 4 illustrates a three-dimensional assembly diagram of the waterway board component and the bracket component provided by an embodiment of the present disclosure, viewed from a second angle;

FIG. 5 illustrates a three-dimensional exploded diagram of the water purifier provided by an embodiment of the present disclosure, viewed from a first angle;

FIG. 6 illustrates a three-dimensional exploded diagram of the water purifier provided by an embodiment of the present disclosure, viewed from a second angle;

FIG. 7 illustrates a three-dimensional exploded diagram of the water purifier provided by an embodiment of the present disclosure, viewed from a third angle;

FIG. 8 illustrates a three-dimensional exploded diagram of the water purifier provided by an embodiment of the present disclosure, viewed from a fourth angle;

FIG. 9 illustrates a three-dimensional exploded diagram of the water purifier provided by an embodiment of the present disclosure, viewed from a fifth angle;

FIG. 10 illustrates a three-dimensional exploded diagram of the water purifier provided by an embodiment of the present disclosure, viewed from a sixth angle;

FIG. 11 illustrates a three-dimensional exploded diagram of the water purifier provided by an embodiment of the present disclosure, viewed from a seventh angle;

FIG. 12 illustrates a three-dimensional diagram of a main housing of the water purifier provided by an embodiment of the present disclosure;

FIG. 13 illustrates a cross-sectional diagram of the water purifier provided by an embodiment of the present disclosure;

FIG. 14 illustrates structural diagram I of a waterway board component provided by an embodiment of the present disclosure;

FIG. 15 illustrates schematic structural diagram II of a waterway board component provided by an embodiment of the present disclosure;

FIG. 16 illustrates a structural diagram of a first cover plate in the waterway board component provided by an embodiment of the present disclosure;

FIG. 17 illustrates a structural diagram of a second cover plate in the waterway board component provided by an embodiment of the present disclosure;

FIG. 18 illustrates a structural diagram of a first base in the waterway board component provided by an embodiment of the present disclosure;

FIG. 19 illustrates a structural diagram of a second base in the waterway board component provided by an embodiment of the present disclosure;

FIG. 20 illustrates a structure diagram of various connection ports on a second mounting portion in the waterway board component provided by an embodiment of the present disclosure.

### DETAILED DESCRIPTION OF THE EMBODIMENTS

The technical solutions in this embodiments of the present disclosure will be clearly and completely described below with reference to the drawings in this embodiments of the present disclosure, and it is obvious that the described embodiments are only a part of the embodiments of the present disclosure but not all of them. All other embodiments obtained by a person of ordinary skill in the art based on the embodiments of present disclosure without making creative labors shall fall within the protection scope of present disclosure.

This specification and claims of the present disclosure, and terms “first” and “second” in the above accompanying drawings are configured to distinguish different objects, but are unnecessarily configured to describe a specific sequence. In addition, the term “include”, “has”, and any variant thereof are intended to cover a non-exclusive inclusion. For example, a process, method, system, product, or device that includes a series of steps or units is not limited to the listed steps or units; and instead, further optionally includes a step or unit that is not listed, or further optionally includes another step or unit that is intrinsic to the process, method, product, or device.

Reference to “embodiment” or “implementation” herein means that a particular feature, structure or characteristic described in conjunction with an embodiment or an implementation may be included in at least one embodiment of the present disclosure. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described herein may be combined with other embodiments.

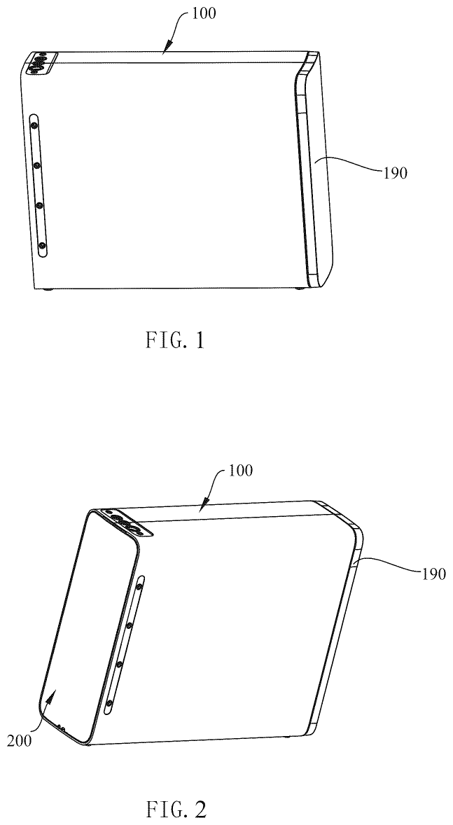

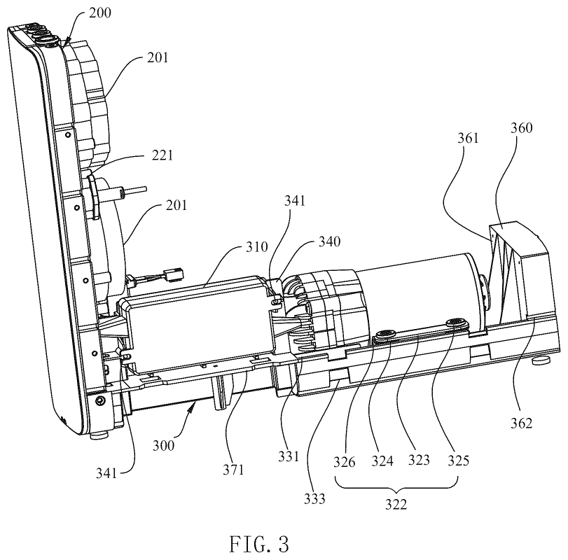

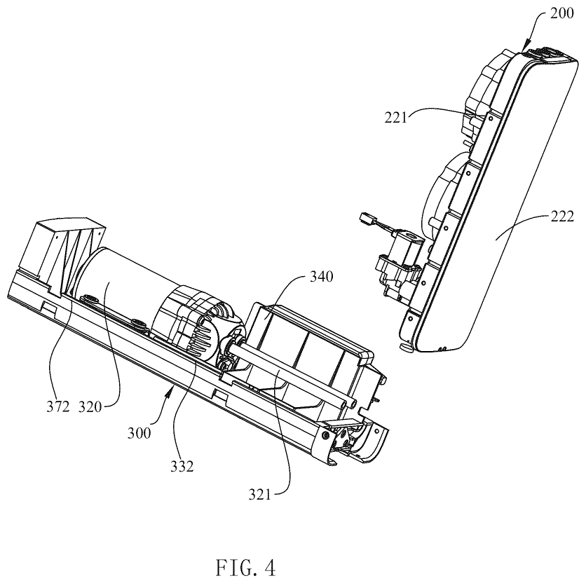

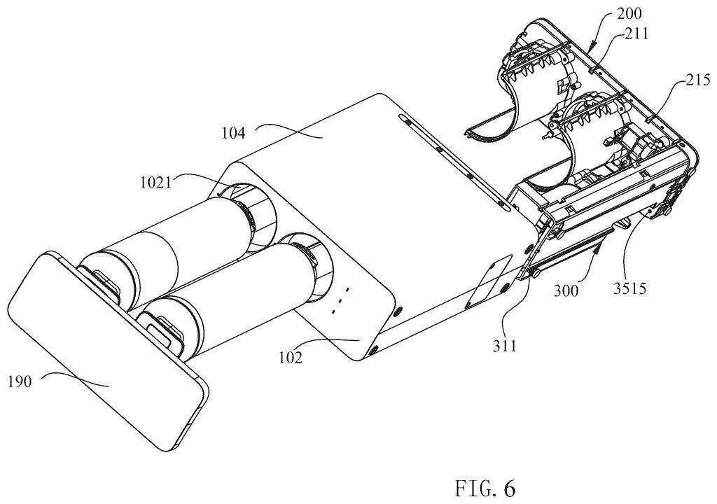

As shown in FIG. 1 to FIG. 6, the embodiment provides a water purifier, including a main housing 100, a waterway board component 200, and a bracket component 300. A mounting opening 101 is provided on one surface (back surface) of the main housing 100. The waterway board component 200 and the bracket component 300 are inserted into the main housing 100 from the mounting opening 101. At least two first reinforcing ribs 111 and at least two second reinforcing ribs 112 are respectively arranged on the opposite first side wall 103 and second side wall 104 of the main housing 100. Both the first reinforcing ribs 111 and the second reinforcing ribs 112 extends into the main housing 100 along the mounting opening 101. First limiting slots 211 and second limiting slots 212 are provided in two sides of the waterway board component 200 or/and the bracket component 300. The first limiting slots 211 are clamped to the first reinforcing ribs 111, and the second limiting slots 212 are clamped to the second reinforcing ribs 112. By coordinating the reinforcing ribs and the limiting slots, the two sides of the waterway board component 200 and/or the bracket component 300 can be reliably connected to the main housing 100. Therefore, it is not easy to produce abnormal noise during long-term use, with high structural stability and a good user experience.

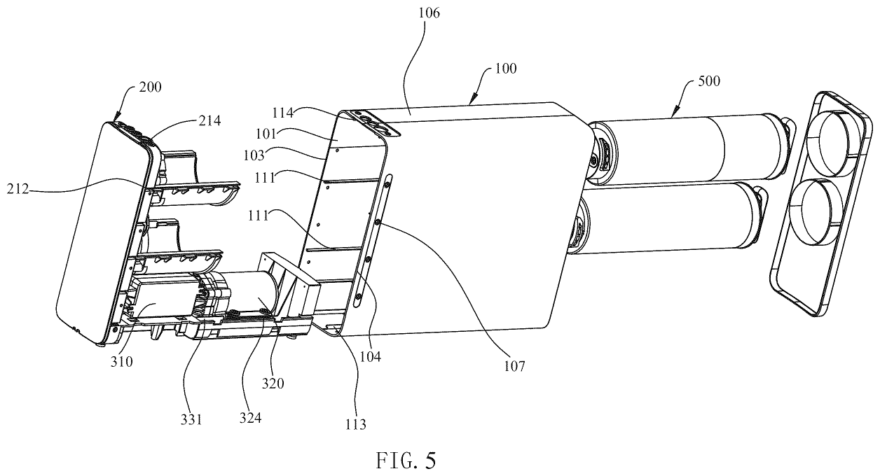

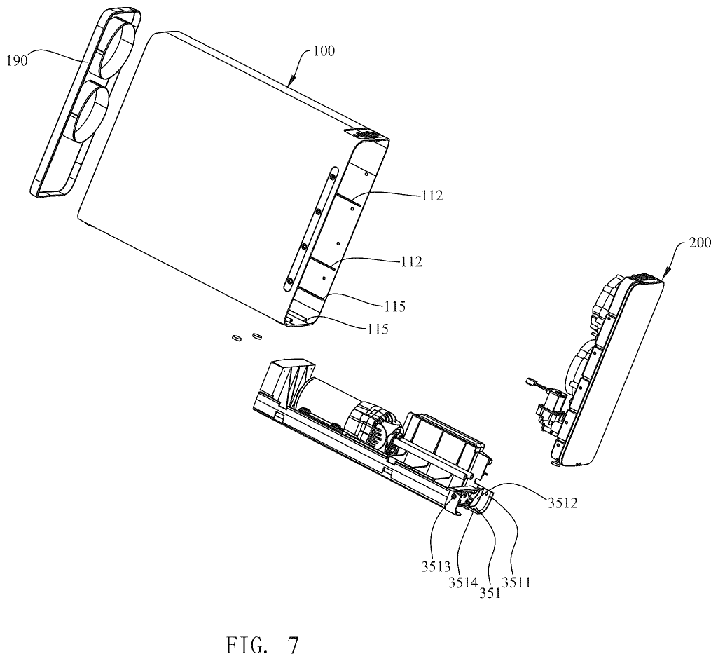

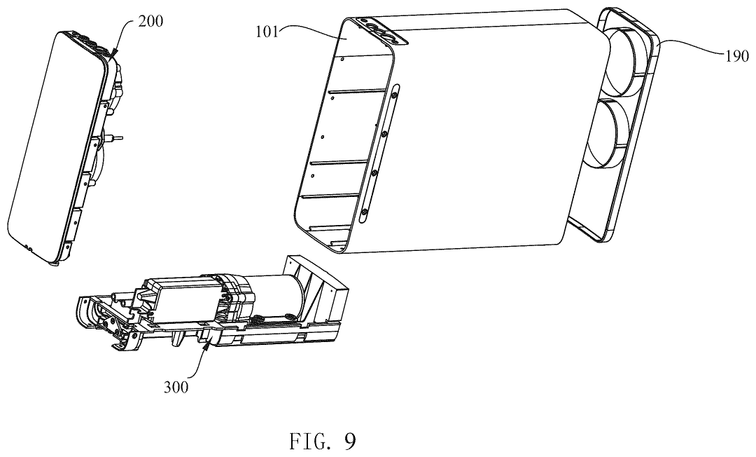

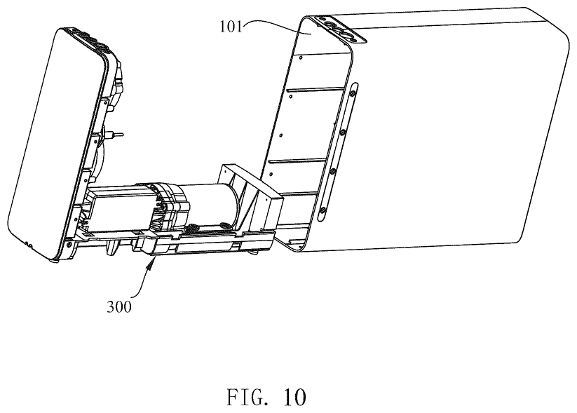

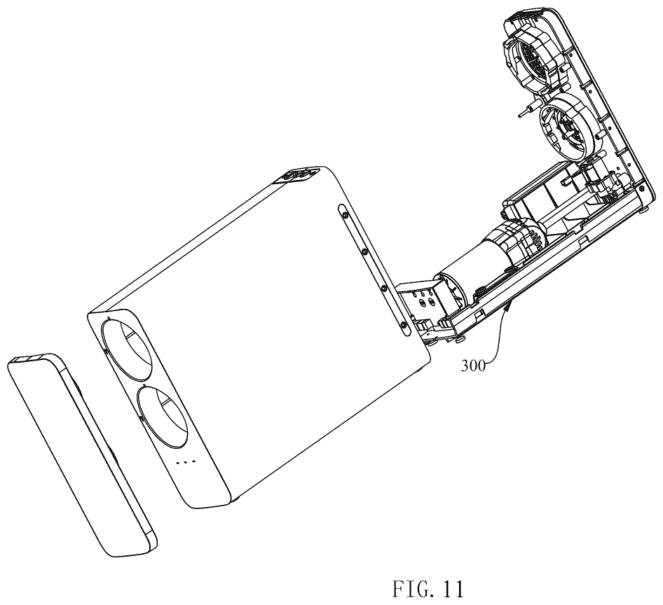

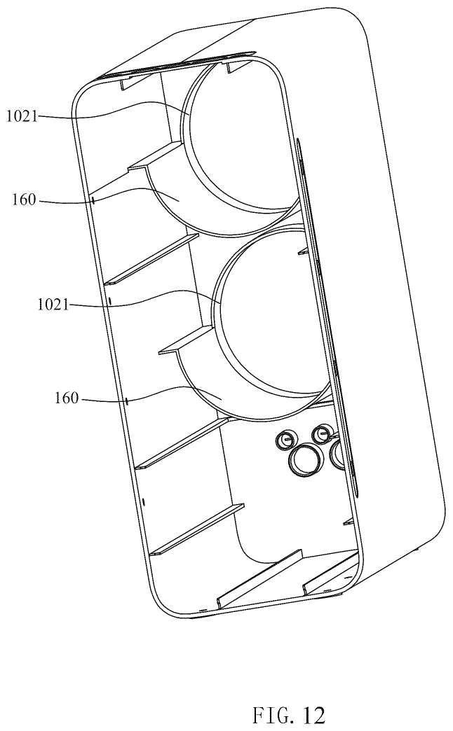

Specifically, the waterway board component 200 closes the mounting opening 101, meaning that an outer side surface of the waterway board component 200 serves as an appearance surface 222 of the water purifier. As shown in FIG. 5 to FIG. 11, in this embodiment, a mounting opening 101 is provided in a back surface of the main housing 100. The waterway board component 200 and the bracket component 300 are connected to form a waterway board integrated component. The waterway board integrated component is inserted into the main housing 100 as a whole from the mounting opening 101, and the waterway board component 200 closes the mounting opening 101. In this embodiment, the entire back surface of the main housing 100 is set as the mounting opening 101, and four sides of the waterway board component 200 are connected to an inner side wall of the main housing 100. The main housing 100 is of an integrated structure. A filter element mounting hole 1021 is provided in a front panel 102 on a front surface of the main housing, and the back surface is designed with a full opening. The waterway board integrated component is directly connected to an inner side of the main housing 100. The product has a compact structure, is convenient to assemble, and has a low production cost.

Specifically, two opposite side walls of the main housing 100 are a first side wall 103 and a second side wall 104, respectively. A first reinforcing rib 111 and a second reinforcing rib 112 are respectively arranged on the opposite first side wall 103 and second side wall 104 of the main housing 100. The first reinforcing rib 111 and the second reinforcing rib 112 both extend in a direction from the mounting opening 101 towards the front panel 102 of the main housing 100. Limiting clamping slots (first limiting slots 211 and second limiting slots 212) are provided in two sides of the waterway board component 200 and two sides of the bracket component 300. The first limiting slots 211 are clamped to the first reinforcing rib 111, and the second limiting slots 212 are clamped to the second reinforcing rib 112. The stability of mounting of the various components is good, without a need for excessive screws or buckle structures, which is conducive to further improving the assembling efficiency and reducing the cost. Further, by the arrangement of the reinforcing ribs, the structural strength of the main housing 100 is effectively improved, to preventing deformation of the main housing 100 and achieve higher structural reliability.

Specifically, in this embodiment, a lower side wall (bottom wall) of the main housing 100 is defined as a third side wall 105, and an upper side wall (top wall) of the main housing 100 is defined as a fourth side wall 106. The first side wall 103 and the second side wall 104 are arranged facing each other, and the third side wall 105 and the fourth side wall 106 are arranged facing each other. The first side wall 103, the second side wall 104, the third side wall 105, and the fourth side wall 106 are enclosed to form a rectangular frame. The front panel 102 of the main housing 100 is integrally connected to the first side wall 103, the second side wall 104, the third side wall 105, and the fourth side wall 106, thereby forming a housing structure with an opening in a back surface. A bottom of the bracket component 300 is connected to the third side wall 105 of the main housing 100. A third reinforcing rib 213 is arranged on the third side wall 105 of the main housing 100. The third reinforcing rib 213 extends into the main housing 100 along the mounting opening 101. The bracket component 300 is provided with a plurality of convex ribs 311. The convex ribs 311 are connected to the third reinforcing rib 213 in a staggered manner. Alternatively, a limiting slot is formed between two convex ribs 311, and the third reinforcing rib 213 is clamped in the limiting slot, which achieves a good mounting and a positioning effect. A gap is reserved between the bottom of the bracket component 300 and an inner bottom of the main housing 100. Even if water is accumulated in the main housing 100 due to water leakage, the bracket component 300 can be prevented can be prevented from being directly soaked by the accumulated water. A fourth limiting slot 214 is provided in a top of the waterway board component 200. A fourth reinforcing rib 114 is arranged on the fourth side wall 106 of the main housing 100. The fourth reinforcing rib 114 extends into the main housing 100 along the mounting opening 101, and is clamped in the fourth limiting slot 214. In this way, the waterway board integrated component is assembled and constrained by the ribs and slots matching structures in four directions, so that its internal structure is stable. The waterway board component 200 overall covers the mounting opening 101 on the back surface of the main housing 100. A waterway connection port can be provided in the fourth side wall 106 of the main housing 100. A connection port of the waterway board component 200 is flush with the waterway connection port.

Specifically, one surface of the waterway board component 200 facing an inner cavity of the main housing 100 is a waterway connection surface 221. One surface of the waterway board component 200 facing away from the inner cavity of the main housing 100 is an appearance surface 222 exposed out of the mounting opening 101. The waterway connection surface 221 is provided with a filter element plugging structure 201. The filter element plugging structure 201 (i.e. a filter element plugging base) faces a filter element mounting hole 1021 of the front panel 102. One end of the first limiting slot 211 and one end of the second limiting slot 212 penetrate into the waterway connection surface 221, and the other end of the first limiting slot 211 and the other end of the second limiting slot 212 have a predetermined distance from the appearance surface 222. Namely, when the waterway board component 200 is plugged into the mounting opening 101, its mounting depth is easily found, which is conducive to improving a mounting efficiency. The first limiting slot 211 and the second limiting slot 212 are not exposed out of the appearance surface 222 of the waterway board component 200.

Specifically, the waterway board component 200 includes a first cover plate 10 and a second cover plate 20. One surface of the first cover plate 10 and one surface of the second cover plate 20 are fixedly connected towards each other to form a waterway chamber. The other surface of the first cover plate 10 is the waterway connection surface 221, and the other surface of the second cover plate 20 is the appearance surface 222. The appearance surface 222 is flush with an edge of the mounting opening 101 of the main housing. The first limiting slot 211 and the second limiting slot 212 are provided in the first cover plate 10. The first limiting slot 211 and the second limiting slot 212 penetrates to the waterway connection surface 221 from the surface of the first cover plate 10 connected to the second cover plate 20. Namely, the first reinforcing rib 111 and the second reinforcing rib 112 extend into the first limiting slot 211 and the second limiting slot 212, and end portions of both the first reinforcing rib 111 and the second reinforcing rib 112 press against the second cover plate 20. The entire second cover plate 20 closes the mounting opening 101, and the limiting slots and the reinforcing ribs are not exposed out of the appearance surface 222.

Specifically, cross sections of both the first reinforcing rib 111 and the second reinforcing rib 112 are in suitable shapes such as rectangle, dovetail, L, Y, or T. Shapes of the cross sections of both the first limiting slot 211 and the second limiting slot 212 are matched with the shapes of the first reinforcing rib 111 and the second reinforcing rib 112. In this embodiment, rectangular (linear shaped) reinforcing ribs are taken as an example. This achieves a simple structure and a low cost. Of course, the reinforcing ribs may also be a dovetail-shaped, a L-shaped, and the like. When the limiting slots cooperate with the reinforcing ribs, the main housing 100 can be prevented from bulging and deforming outward.

Specifically, bayonet slots 115 are provided in one end of the first reinforcing rib 111 close to the mounting opening 101 and one end of the second reinforcing rib 112 close to the mounting opening 101. The bayonet slots 115 are arranged close to the inner side wall of the main housing 100. The waterway board component 200 is provided with convex blocks 215 at the first limiting slot 211 and the second limiting slot 212. The convex blocks 215 are inserted into the bayonet slots 115 to prevent the mounting opening 101 from deforming outward due to a force, thereby better improving a stability of mounting.

Specifically, the bracket component 300 is fixedly connected to the waterway board component 200 to form an electric-water total assembly module.

Specifically, a bottom of the bracket component 300 is connected to the third side wall 105 of the main housing 100. A third reinforcing rib 213 is arranged on the third side wall 105 of the main housing 100. The bracket convex ribs 311 are connected to the third reinforcing rib 213 in a staggered manner. Alternatively, a limiting slot is formed between two bracket convex ribs 311, and the third reinforcing rib 213 is clamped in the limiting slot, which achieves an excellent structural reliability.

Specifically, the bracket component 300 is provided with a plurality of bracket convex ribs 311, a third limiting slot is formed between the two bracket convex ribs 311, and/or, bayonet slots 115 are provided in one end of the third reinforcing rib 213 close to the mounting opening 101. The bayonet slots 115 are arranged close to the inner side wall of the main housing 100. The waterway board component 200 is provided with convex blocks at the third reinforcing rib. The convex blocks are inserted into the bayonet slots 115 to prevent the mounting opening 101 from deforming outward due to a force, thereby better improving a stability of mounting.

Specifically, a fourth limiting slot 214 provided in a top of the waterway board component 200. A fourth reinforcing rib 114 is arranged on the fourth side wall 106 of the main housing 100. The fourth reinforcing rib 114 extends into the main housing 100 along the mounting opening 101, and is clamped in the fourth limiting slot 214, so that the structural reliability is good.

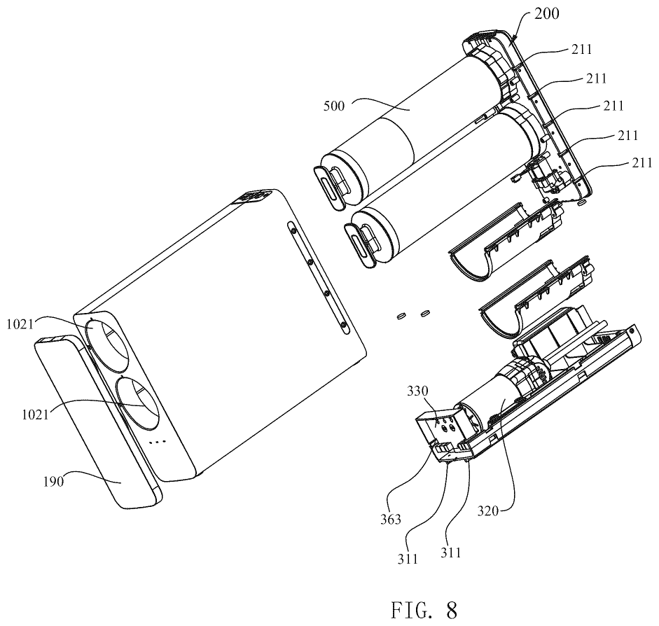

Specifically, as shown in FIG. 8 to FIG. 12, the main housing 100 has a front panel 102, which is used as a filter element mounting side. The filter element mounting side is provided with a filter element mounting hole 1021 for the filter element component 500 to be inserted, and the filter element component 500 can be butted to the filter element plugging structure 201 of the waterway board component 200. A main lining plate 160 is integrally arranged in the filter element mounting hole 1021, and the main lining plate 160 extends from an edge of the filter element mounting hole 1021 to a direction of the filter element plugging structure 201. There is a predetermined distance between the main lining plate 160 and the filter element plugging structure 201. Due to an injection molding process, when the main lining plate 160 extends to a position close to the mounting opening 101, it is difficult for forming. Therefore, during production, the main lining plate 160 has a predetermined distance from the mounting opening 101 on the back surface of the main housing 100. This makes a molding of the main lining plate 160 relatively easier, thereby reducing a production cost of the main housing 100.

Below the filter element plugging structure 201, the waterway connection surface 221 is fixedly connected to an auxiliary lining plate 610. One end of the auxiliary lining plate 610 is fixed to the waterway connection surface 221, while the other end abuts against the edge of the main lining plate 160. Therefore, from the filter element mounting hole 1021, there is no obvious hollow portions, so that an user experience is good. Lining plate limiting slots 611 are provided in the two sides of the auxiliary lining plate 610. The lining plate limiting slots 611 sleeves the first reinforcing rib 111 and the second reinforcing rib 112, ensuring excellent installation reliability of the auxiliary lining plate 610.

Specifically, the auxiliary lining plate 610 is cylindrical or semi-cylindrical. A front end of the auxiliary lining plate 610 is provided with a fitting portion for sticking to the outer circumference of the end of the main lining plate 160. A connection between the auxiliary lining plate 610 and the main lining plate 160 can also adopt a plug-sleeve fitting structure, which is reliable.

Specifically, the bracket component 300 has a first end and a second end which are opposite to each other in the lengthwise direction. The bracket component 300 is provided with a power supply mounting position and a booster pump mounting position in a direction from the first end to the second end. A power supply module 310 is mounted at the power supply mounting position, and a booster pump 320 is mounted at the booster pump mounting position. In a width direction of the bracket component 300, a strong electricity line mounting position 331 and a weak electricity line mounting position 332 are respectively arranged on two sides of the booster pump mounting position. Wires can be placed in a manner of separating strong electricity from weak electricity, so that the reliability is good.

In specific application, the waterway board component 200 can be provided with a Total Dissolved Solids (TDS) sensor and a Negative Temperature Coefficient thermistor (NTC) temperature sensor. A control circuit board 330 is arranged at a second end of the bracket component 300, and the TDS sensor and NTC temperature sensor can be connected to the control circuit board 330 through the weak electricity line mounting position 332. A power cable of the booster pump 320 can be arranged at the strong electricity line mounting position 331.

Specifically, a sinking groove is provided in the booster pump mounting position. The strong electricity line mounting position 331 is a first recessed groove arranged on one side of the sinking groove, and the first recessed groove is separated from the sinking groove by a first partition plate. The weak electricity line mounting position 332 is a second recessed groove arranged on the other side of the sinking groove, and the second recessed groove is separated from the sinking groove by a second partition plate. Cable tie passing holes 333, which connect to the first recessed groove and the second recessed groove, are provided on two sides of the bracket component 300 along a width direction. Cables can be fixed by cable ties to prevent cable looseness from affecting product reliability.

Specifically, the mounting bracket 322 includes a supporting plate 326. The supporting plate 326 is fixed to an outer side of the booster pump 320. The supporting plate 326 is semi-cylindrical and is arranged in the sinking groove; two sides of the supporting plate 326 extend outward to form flange parts 323; the flange parts 323 are located on two outer sides of the sinking groove; booster pump mounting holes are provided in the flange parts 323; the bracket component 300 is provided with a booster pump fixing column; the booster pump fixing column is arranged below the booster pump mounting holes; the supporting plate 326 is connected to the booster pump fixing column through a booster pump locking component 324 (a screw); a buffer sleeve 325 (rubber sleeve) is arranged between the supporting plate 326 and the booster pump fixing column; and the buffer sleeve 325 sleeves the booster pump locking component 324. A buffer effect of the booster pump 320 is good.

Specifically, the power supply mounting position is close to the first end of the bracket component 300. A partition plate 340 is provided on one side of the power supply mounting position and the partition plate 340 extends in a direction from the first end to the second end of the bracket component 300 to the booster pump mounting position. The power supply module 310 is fixed on one side of the partition plate 340. The booster pump 320 is connected to the waterway board component 200 through a connecting pipe 321. The connecting pipe 321 is arranged on the other side of the partition plate 340. Even if water leaks from the connecting pipe 321, the power supply module 310 will not be directly affected by the water leakage, and the reliability is better.

Specifically, the waterway board component 200 is in “L” shaped connection with the bracket component 300; and the bracket component 300 is arranged close to one end of the waterway board component 200. The waterway board component 200 can be longitudinally designed. The bracket component 300 is transversely connected to a bottom of one side of the waterway board component 200, to form an L-shaped integrated structure. The L-shaped integrated structure can be overall plugged into the main housing 100 and is fixed to the main housing 100. The bracket component 300 can be close to one side of a bottom of the main housing 100, so that the stability is good. Or, of course, the bracket component 300 can be close to an inner top of the main housing 100. Even if water leaks from the connection port of the filter element component 500, the electrical components such as the power supply module 310 and the booster pump 320 will not be affected, and the reliability is good. During mounting of the water purifier, the filter element component 500 can be horizontally arranged. The front panel 102 of the main housing 100 faces forward for easy replacement of the filter element component 500.

Alternatively, the waterway board component 200 can be in (lateral) “T” shaped connection with the bracket component 300; and the bracket component 300 is arranged close to a middle part of one side of the waterway board component 200. The waterway board component 200 can be designed longitudinally, and the bracket component 300 is horizontally connected to the middle part of one side of the waterway board component 200, thereby forming a lateral “T”-shaped integrated structure. The entire lateral “T” shaped integrated structure can be plugged into the main housing 100 and fixed to the main housing 100. A front end of the bracket component 300 can be butted with an inner side of the front panel 102 of the main housing 100, and two groups of filter element components 500 can be respectively arranged on two sides of the bracket component 300. During mounting of the water purifier, the filter element component 500 can be longitudinally arranged. The front panel 102 of the main housing 100 faces upward for easy replacement of the filter element component 500.

Specifically, the bracket component 300 has a power supply mounting position configured to mount the power supply module 310, and a booster pump mounting position configured to mount the booster pump 320. The power supply mounting position and the booster pump mounting position are arranged in sequence in a lengthwise direction of the bracket component 300. The bracket component 300 has a first end and a second end in the lengthwise direction. The first end of the bracket component 300 is fixedly connected to the waterway board component 200. The power supply mounting position is close to the first end of the bracket component 300, and the booster pump mounting position is close to the second end of the bracket component 300. By using of a space in the lengthwise direction of the filter element component 500, the power supply module 310 and the booster pump 320 are properly arranged, so that a length of the entire water purifier is only slightly greater than that of the filter element component 500.

Specifically, at least two power supply module fixing columns 341 are arranged on one side of the partition plate 340; the power supply module fixing columns 341 are provided with screw holes; the power supply module 310 is fixed with a lug part; the lug part has a hole for allowing a power supply module locking component to pass through; the power supply module 310 is fixed to the power supply module fixing columns 341 through the power supply module locking component (a screw); and a bottom of the power supply module 310 is suspended relative to the bracket component 300. In this way, the power supply module 310 is suspended relative to inner bottoms of both the bracket component 300 and the main housing 100. Even if water is accumulated in the main housing 100 due to water leakage, the power supply module 310 will not be directly affected, so that the safety and the reliability are better.

Specifically, the main housing 100 has a first side wall 103 and a second side wall 104 which are opposite to each other. Two sides of the bracket component 300 are respectively connected to the first side wall 103 and the second side wall 104. The main housing 100 also has a third side wall 105, and at least two housing convex ribs (third reinforcing ribs 213) are arranged on the third side wall 105. The bottom of the bracket component 300 is provided with at least two bracket convex ribs 311, and the housing convex ribs are connected to the bracket convex ribs 311 in a staggered manner. Two bracket convex ribs 311 are designed between adjacent housing convex ribs, or two housing convex ribs are designed between adjacent bracket convex ribs 311. In this way, the bracket component 300 can be reliably limited, and the design of the housing convex ribs also enhances the structural strength of the main housing 100, avoiding deformation of the main housing 100 and improving structural reliability.

Specifically, a first side surface flange 371 and a second side surface flange 372 are arranged on two sides of the bracket component 300. Outer side surfaces of the first side surface flange 371 and the second side surface flange 372 resist against the first side wall 103 and the second side wall 104 of the main housing 100. A first reinforcing rib 111 and a second reinforcing rib 112 are respectively arranged on the first side wall 103 and the second side wall 104 of the main housing 100. Surfaces, facing the third side wall 105, of both the first reinforcing rib 111 and the second reinforcing rib 112 are clamping surfaces. Upper ends of the first side surface flange 371 and the second side surface flange 372 are clamped to the clamping surfaces, which can restrict longitudinal movement of the bracket component 300, so that the structural reliability is good.

Specifically, bayonet slots 115 are provided in one end of the first reinforcing rib 111, one end of the second reinforcing rib 112 and one end of the housing convex ribs close to the mounting opening 101. The bayonet slots 115 are arranged close to the inner side wall of the main housing 100. The waterway board component 200 is provided with convex blocks 215 at the first limiting slot 211 and the second limiting slot 212. The convex blocks 215 are inserted into the bayonet slots 115. Specifically, bayonet slots 115 are provided in one end of the housing convex ribs close to the mounting opening 101. The bayonet slots 115 are arranged close to the inner side wall of the main housing 100. The waterway board component 200 or the bracket component 300 is provided with the convex blocks 215 at the first limiting slot 211. The convex blocks 215 are inserted into the bayonet slots 115 to prevent the mounting opening 101 from deforming outward due to a force, thereby better improving a stability of mounting.

Specifically, the second end of the bracket component 300 is fixedly or integrally provided with a control board mounting frame 360, and a control circuit board 330 is arranged in the control board mounting frame 360. A back surface sealing plate 361 is arranged on one surface of the control board mounting frame 360 close to the first end, and an opening is provided in one surface of the control board mounting frame 360 close to the second end. The opening resists against an inner wall of the main housing 100, thereby forming a control board accommodating chamber. The control circuit board 330 is encapsulated in the control board accommodating chamber, which is not easily affected by water vapor inside the main housing 100 and has good reliability. The control circuit board 330 is integrated into the bracket component 300, which can facilitate assembly, improve assembly efficiency, and reduce costs.

Specifically, the control board mounting frame 360 resists against the inner side of the front panel 102 of the main housing 100. The control circuit board 330 is provided with an indicator lamp. The front panel 102 on the front surface of the main housing 100 is provided with an indicator lamp light-transmittance region corresponding to the indicator lamp for a user to identify a working state of the product.

Specifically, the back surface sealing plate 361 is provided with a wire passing hole for a cable to pass through. The control circuit board 330 abuts against the back surface sealing plate 361. The control circuit board 330 is located above the wire passing hole. The control circuit board 330 is positioned relatively upward to avoid the influence and interference of water vapor.

Specifically, a sealing rubber pad can be arranged at an edge of the opening. The control board mounting frame 360 resists against the inner side of the front panel 102 through the sealing rubber pad. Or, the edge of the opening can directly resist against the inner side of the front panel 102 to form a relatively closed control board accommodating chamber.

Specifically, two sides and a bottom of the bracket component 300 are connected to the main housing 100. A first reinforcing rib 111 and a second reinforcing rib 112 are respectively arranged on the first side wall 103 and the second side wall 104 of the main housing 100. The control board mounting frame 360 is provided with mounting frame limiting slots 362 on two sides. The first reinforcing rib 111 and the second reinforcing rib 112 are respectively clamped in the mounting frame limiting slots 362. The limiting effect on the bracket component 300 is good.

Specifically, an inner convex part 363 is arranged on an inner side wall of the control board mounting frame 360. The mounting frame limiting slots 362 are placed from the inner convex part 363 of the control board mounting frame 360. The control circuit board 330 is provided with a notch. The notch is clamped with the inner convex part 363. The control circuit board 330 is fixed to the control board mounting frame 360 through a circuit board locking component, so that it is convenient to mount the control circuit board 330.

Specifically, a supporting slot 351 is provided in one end of the bracket component 300. The waterway board component 200 is partially inserted into the supporting slot 351 and is limited by the supporting slot 351. The bracket component 300 is provided with locking components on two sides or/and at a bottom of the supporting slot 351, for locking the waterway board component 200 to the bracket component 300 is equipped with locking components on both sides or/and the bottom of the support groove 351 for locking the waterway board component 200 to the bracket component 300. The fixing reliability between the bracket component 300 and the waterway board component 200 is excellent.

Specifically, a filter element mounting hole 1021 is provided in a front surface of the main housing 100. The filter element mounting hole 1021 is configured to allow a filter element component 500 to extend into the main housing 100. A waterway board component 200 is arranged on a back surface of the main housing 100. One side of the waterway board component 200 facing the filter element mounting hole 1021 is a waterway connection surface 221. The waterway connection surface 221 is provided with a filter element plugging structure 201. The filter element plugging structure 201 is configured to allow the filter element component 500 to be plugged. The filter element plugging structure 201 faces the filter element mounting hole 1021. A main lining plate 160 is integrally arranged in the main housing 100. A first end of the main lining plate 160 is integrally connected to an edge of the filter element mounting hole 1021. A hollow distance is provided between a second end of the main lining plate 160 and the waterway board component 200, and an auxiliary lining plate 610 is arranged at the hollow distance. A first end of the auxiliary lining plate 610 is connected to the waterway connection surface 221 of the waterway board component 200. The auxiliary lining plate 610 is located below the filter element plugging structure 201. A set distance is provided between the main lining plate 160 and the filter element plugging structure 201. Due to an injection molding process, when the main lining plate 160 extends to a position close to the mounting opening 101, it is difficult for forming. The main lining plate 160 has the set distance from the mounting opening 101 on the back surface of the main housing 100, to reduce the production cost of the main housing 100, The second end of the auxiliary lining plate 610 is butted with an end portion of the main lining plate 160. Due to the butting between the main lining plate 160 and the auxiliary lining plate 610, the internal structure of the main housing 100 is more stable. Therefore, from the filter element mounting position 1021, no obvious hollow portions below the filter element component 500, so that an user experience is good.

Specifically, the filter element component 500 is cylindrical, and a cross section of the main lining plate 160 is semi-cylindrical or cylindrical, to match the shape of the filter element component 500.

Specifically, a cross section of the auxiliary lining plate 610 is semi-cylindrical or cylindrical. In this embodiment, both the auxiliary lining plate 610 and the main lining plate 160 are semi-cylindrical. This achieves a simple structure and low cost.

Specifically, the first end of the auxiliary lining plate 610 is fixedly connected to the waterway board component 200 through a lining plate locking component, and an end clamping slot is provided in the second end of the auxiliary lining plate 610. The end clamping slot sleeves an edge of an end portion of the second end of the main lining plate 160. Alternatively, an end clamping slot is provided in the second end of the main lining plate 160. The second end of the auxiliary lining plate 610 is plugged into the end clamping slot. By opposite plugging, the auxiliary lining plate 610 and the main lining plate 160 form a complementary butted structure, thus achieving better structural reliability.

Specifically, lining plate limiting slots 611 are provided in the two sides of the auxiliary lining plate 610. The lining plate limiting slots 611 are aligned with one of the first limiting slots 211 and one of the second limiting slots 212 and are clamped to the first reinforcing ribs 111 and the second reinforcing ribs 112, so that the two sides of the auxiliary lining plate 610 are supported and limited by the first reinforcing ribs 111 and the second reinforcing ribs 112.

Specifically, the two sides of the main lining plate 160 are integrally connected to the first side wall 103 and the second side wall 104 of the main housing 100 through connecting ribs. An integral connection structure is provided between the first side wall 103 and the second side wall 104. This achieves better structural stability.

Specifically, the two sides of the main lining plate 160 are integrally connected to the first side wall 103 and the second side wall 104 of the main housing 100 through connecting ribs. An integral connection structure is provided between the first side wall 103 and the second side wall 104. This achieves better structural stability.

Specifically, at least two filter element mounting holes 1021 are provided in the front surface of the main housing 100, and the waterway board component 200 is correspondingly provided with at least two filter element plugging structures 201. A surface cover plate 190 is arranged on the front surface of the main housing 100. The surface cover plate 190 can cover the front panel 102 to block the filter element mounting holes 1021. This achieves better appearance consistency.

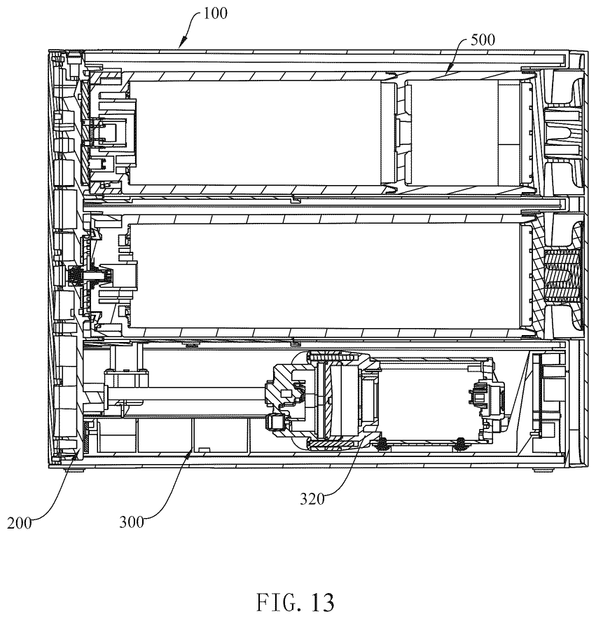

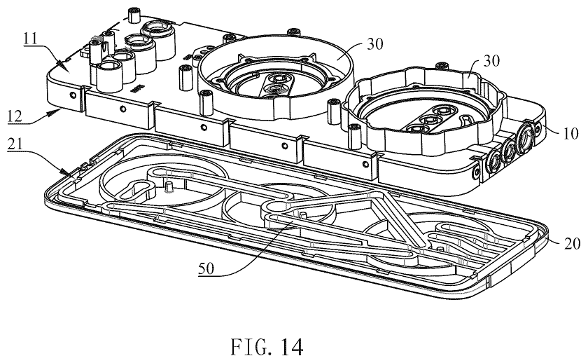

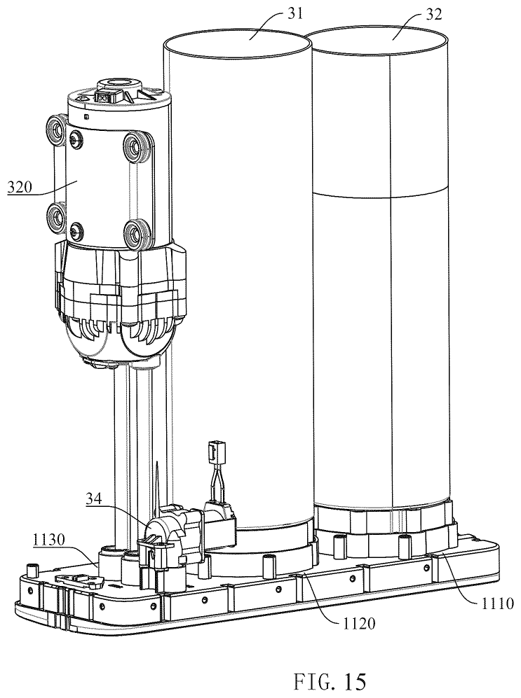

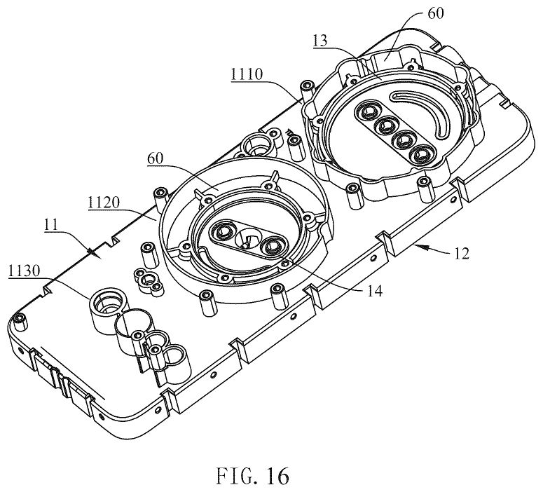

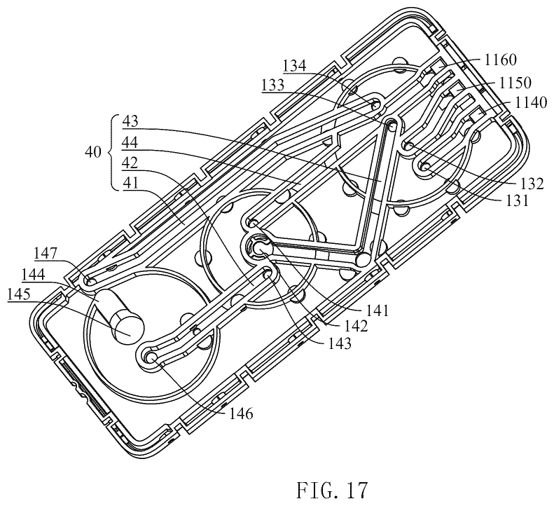

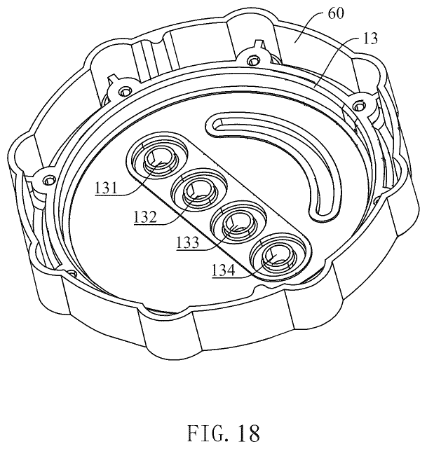

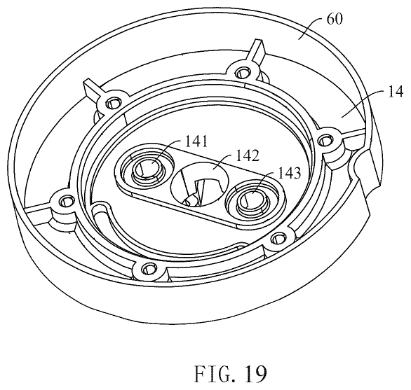

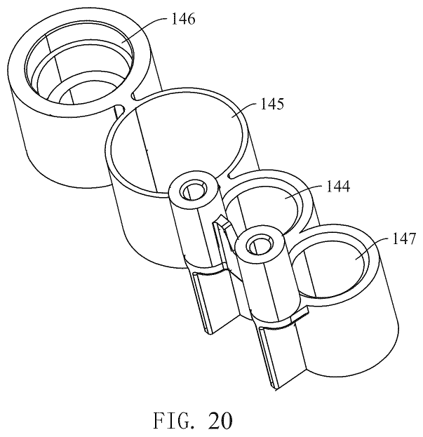

As shown in FIG. 13 to FIG. 20, the above waterway board component 200 includes a first cover plate 10 and a second cover plate 20. The first cover plate 10 and the second cover plate 20 are connected to each other by bonding or laser welding. The first cover plate 10 has a first surface 11 and a second surface 12. Filter element components 500 are arranged on the first surface 11, and flow guide slot structures 40 are arranged on the second surface 12. A plurality of flow guide members 50 are correspondingly arranged on a third surface 21 of the second cover plate 20 facing the second surface 12. By the cooperation between the flow guide members 50 and the flow guide slot structures 40, flow guide channels can be formed. The filter element components 500 arranged on the first surface 11 are communicated through the flow guide channels, so that water can flow in the filter element components 500. The filter element components 500 are directly mounted on the first cover plate 10 and a waterway board is connected by bonding the first cover plate 10 with the second cover plate 20. This can achieve the purpose of reducing the volume of the water purifier.

In some implementations, the plurality of filter element components 500 include an RO filter element 31 and a composite filter element 32. The first surface 11 is further provided with a first mounting portion 1110, a second mounting portion 1120, and a third mounting portion 1130. The composite filter element 32 is arranged at the first mounting portion 1110. The RO filter element 31 is arranged at the second mounting portion 1120. A booster pump and a water inlet valve 34 are arranged at the third mounting portion 1130.

In some implementations, the first mounting portion 1110 is provided with a first base 13. The composite filter element 32 is arranged on the first base 13.

The first base 13 includes: a first filter element connection port 131, a second filter element connection port 132, a third filter element connection port 133, and a fourth filter element connection port 134.

The first filter element connection port 131, the second filter element connection port 132, the third filter element connection port 133, and the fourth filter element connection port 134 are all communicated to the composite filter element 32.

It can be understood that the first base 13 is arranged on the first mounting portion 1110, so that the first base 13 can play a role of positioning the filter element components 500 mounted on the waterway board component 200, or it can be convenient to directly mount the filter element components 500 on the first base 13, so that the filter element components 500 are in direct contact with the first base 13 and a second base 14. In this way, it can be convenient to mount or remove the filter element components 500 in or from the water purifier.

It can be understood that the first base 13 is further provided with the first filter element connection port 131, the second filter element connection port 132, the third filter element connection port 133, and the fourth filter element connection port 134. The composite filter element 32 includes a first water inlet of composite filter element, a drainage outlet of composite filter element, a second water inlet of composite filter element, and a water outlet of composite filter element.

After the composite filter element 32 is mounted on the first base 13, the first water inlet of composite filter element is mounted at the first filter element connection port 131; the water inlet of composite filter element is mounted at the fourth filter element connection port 134; the second water inlet of composite filter element is mounted at the second filter element connection port 132; and the water outlet of composite filter element is mounted at the water outlet of composite filter element. This achieves the cooperation between the filter element and the first base 13, and communicates the first base 13 to the composite filter element 32.

It can be understood that a polypropylene (PP) membrane and an activated carbon layer are arranged in the composite filter element 32. The PP membrane is configured to filter out large particles in water, and the activated carbon is to remove odor. After passing through the PP membrane, the water will enter the RO filter element 31 for filtration before entering the activated carbon layer for odor removal.

In some implementations, the second mounting portion 1120 is provided with a second base 14, and the RO filter element 31 is arranged on the second base 14.

The second base 14 includes: a fifth filter element connection port 141, a sixth filter element connection port 142, and a seventh filter element connection port 143.

The fifth filter element connection port 141, the sixth filter element connection port 142, and the seventh filter element connection port 143 are all communicated to the RO filter element 31.

It can be understood that the second base 14 is arranged on the second mounting portion 1120. The second base 14 can play a role of positioning the filter element components 500 mounted on the first cover plate 10, and it can be convenient to directly mount the filter element component 500 on the second base 14, so that the filter element components 500 are in direct contact with the second base 14. In this way, it can be convenient to mount or remove the filter element components 500 in or from the water purifier. The fifth filter element connection port 141, the sixth filter element connection port 142, and the seventh filter element connection port 143 are all configured to be communicated with the RO filter element 31. The RO filter 31 is provided with a water inlet of RO filter element, a water outlet of RO filter element, and a wastewater outlet of RO filter element. After the RO filter 31 is mounted on the second base 14, the water inlet of RO filter element is communicated to the seventh filter element connection port 143; the water outlet of RO filter element is communicated to the sixth filter element connection port 142; and the wastewater outlet of RO filter element is communicated to the seventh filter element connection port 143.

In some implementations, the third mounting portion 1130 is provided with a first booster pump connection port 144, a second booster pump connection port 145, a third booster pump connection port 146, and a connection port 147.

The connection port 147 and the first booster pump connection port 144 are both communicated to the water inlet valve 34, and the second booster pump connection port 145 and the third booster pump connection port 146 are both communicated to the booster pump 320.

It can be understood that the third mounting portion 1130 is provided with the first booster pump connection port 144, the second booster pump connection port 145, the third booster pump connection port 146, and the connection port 147. The first booster pump connection port 144, the second booster pump connection port 145, the third booster pump connection port 146, and the connection port 147 are all directly provided in the first surface 11.

The connection port 147 and the first booster pump connection port 144 are communicated to the water inlet valve 34. The connection port 147 is configured to supply water to the water inlet valve 34. The first booster pump connection port 144 is configured to discharge water from the water inlet valve 34.

The second booster pump connection port 145 and the third booster pump connection port 146 are communicated to the booster pump. The second booster pump connection port 145 is configured to supply water to the booster pump. The third booster pump connection port 146 is configured to discharge water from the booster pump.

When water enters the water inlet valve 34 through the connection port 147 and flows to the first booster pump connection port 144, the waters into the booster pump through the first booster pump connection port 144 and the second booster pump connection port 145. The booster pump 320 boosts the water and discharges the water through the third booster pump connection port 146, to achieve the boosting of the water.

In some implementations, the flow guide slot structures 40 include: a first flow guide slot 41, a second flow guide slot 42, a third flow guide slot 43, and a fourth flow guide slot 44.

The first flow guide slot 41 is configured to communicate the fourth filter element connection port 134 to the connection port 147. The second flow guide slot 42 is configured to communicate the third booster pump connection port 146 to the seventh filter element connection port 143. The third flow guide slot 43 is configured to communicate the third filter element connection port 133 to the sixth filter element connection port 142.

It can be understood that the first flow guide slot 41, the second flow guide slot 42, the third flow guide slot 43, and the fourth flow guide slot 44 are all structures that protrude out of the second surface 12, which can reduce a space occupied by the plurality of flow guide slot structures 40 on the first cover plate 10. Specifically, the flow guide slot structures 40 protrude out of the second surface 12, so that a thickness of the first cover plate 10 can be set to be smaller. This can reduce the space occupied by the waterway board component 200 in the water purifier and achieve the purpose of reducing the volume of the water purifier.

It can be understood that the first flow guide slot 41 is configured to communicate the fourth filter element connection port 134 to the connection port 147. The second flow guide slot 42 is configured to communicate the third booster pump connection port 146 to the seventh filter element connection port 143. The third flow guide slot 43 is configured to communicate the third filter element connection port 133 to the sixth filter element connection port 142. In this way, the RO filter element 31, the composite filter element 32, the water inlet valve 34, and the booster pump 320 can be intercommunicated to allow the water to flow in the waterway board component 200.

In some implementations, the first cover plate 10 has a water inlet 1140, a purified water outlet 1150, and a wastewater outlet 1160.

The water inlet 1140 is communicated to the fourth filter element connection port 134. The purified water outlet 1150 is communicated to the third filter element connection port 133. The wastewater outlet 1160 is communicated to the fifth filter element connection port 141 through the fourth flow guide slot 44.

It can be understood that the cover plate has the water inlet 1140, the purified water outlet 1150, and the wastewater outlet 1160. The water inlet 1140, the purified water outlet 1150, and the wastewater outlet 1160 are arranged at a portion, close to the first base 13, of the cover plate. This facilitates feeding of water into the composite filter element 32 and discharging of water after secondary purification. In this way, a length of the first cover plate 10 in a waterway can be reduced.

It can be understood that the water inlet 1140 is configured to supply municipal water to the water purifier. The purified water outlet 1150 is configured to discharge purified water. The wastewater outlet 1160 is configured to discharge wastewater generated in the RO filter element 31. Specifically, the water inlet 1140 is communicated to the first filter element connection port 131. In this way, when water enters the first cover plate 10, the water can directly flow into the composite filter element 32. The purified water outlet 1150 is communicated to the second filter element connection port 132. The water discharged from the purified water outlet 1150 is purified water filtered by activated carbon. The wastewater outlet 1160 is communicated to the fourth flow guide slot 44 and the fifth filter element connection port 141. In this way, the wastewater generated by the RO filter 31 is discharged through the fourth flow guide slot 44 to the wastewater outlet 1160, to discharge the wastewater from the RO filter 31.

A water flowing direction in the above cover plate is as follows: The water enters the waterway board component 200 through the water inlet 1140, then enters the composite filter element 32, and is filtered by the PP membrane. After filtration by the PP membrane, the water is discharged through the fourth filter element connection port 134, then flows into the connection port 147 through the first flow guide slot 41, and enters the water inlet valve 34. After flowing out of the water inlet valve 34, the water flows to the first booster pump connection port 144 and then to the second booster pump connection port 145, and enters the booster pump 320 for boosting through the second booster pump connection port 145. The water is then discharged through the third booster pump connection port 146, thus completing the boosting of the water. The boosted water flows through the second flow guide slot 42 to the seventh filter element connection port 143, and enters the RO filter element 31 through the seventh filter element connection port 143. After the RO filter element 31 filters the water, purified water is discharged from the sixth filter element connection port 142, and wastewater is discharged from the fifth filter element connection port 141. The purified water in the sixth filter element connection port 142 flows through the third flow guide slot 43 to the third filter element connection port 133 and enters an activated carbon filtering layer in the composite filter element 32 for filtration. After flowing out of the activated carbon filtering layer, the purified water is discharged out of the water purifier through the purified water outlet 1150 for drinking. The wastewater generated by the fifth filter element connection port 141 is discharged through the fourth flow guide slot 44 to the wastewater outlet 1160, and is then discharged out of the water purifier.

In some implementations, the first flow guide slot 41, the second flow guide slot 42, the third flow guide slot 43, and the fourth flow guide slot 44 all protrude out of the second surface 12.

It can be understood that the first flow guide slot 41, the second flow guide slot 42, the third flow guide slot 43, and the fourth flow guide slot 44 all protrude out of the second surface 12. This is to facilitate a cooperation with the flow guide members 50. The flow guide members 50 can be clamped into the flow guide slots. When the flow guide members 50 are clamped into the above various flow guide slots, the first cover plate 10 and the second cover plate 20 can cooperate with each other to improve a tightness of the cooperation between the flow guide members 50 and the flow guide slots.

In some implementations, both the first base 13 and the second base 14 have limiting parts 60. The limiting parts 60 all protrude out of the first surface 11.

It can be understood that both the first base 13 and the second base 14 have the limiting parts 60, and the limiting parts 60 protrude out of the first surface 11. In this way, it is convenient to mount the RO filter element 31 and the composite filter element 32 onto the first base 13 and the second base 14. Specifically, both the first base 13 and the second base 14 protrude out of the second surface 12, so that during the mounting of the composite filter element 32 and the RO filter element 31, the first base 13 and the second base 14 can play a positioning role to facilitate the mounting of the RO filter element 31 and the composite filter element 32.

Reference to “embodiment” or “implementation” in the present disclosure means that a particular feature, structure or characteristic described in conjunction with an embodiment may be included in at least one embodiment of the present disclosure. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described in the present disclosure may be combined with other embodiments. In addition, it should be further understood that provided that there is no contradiction between the features, structures or characteristics described in the various embodiments of the present disclosure, the features, structures, or characteristics can be arbitrarily combined to form another embodiment that does not depart from the spirit and scope of the technical solutions of the present disclosure.

Finally, it should be noted that the above implementations are only configured to explain the technical solutions of the present disclosure and not intended to limit the technical solutions. Although the present disclosure has been described in detail with reference to the preferred implementations, those of ordinary skill in the art should understand that the technical solutions of the present disclosure can be modified or equivalently replaced without departing from the spirit and scope of the technical solutions of the present disclosure.

What is claimed is:

1. A water purifier, comprising a main housing, a waterway board component, and a bracket component, a mounting opening is provided on one surface of the main housing, the waterway board component and the bracket component are inserted into the main housing from the mounting opening, at least two first reinforcing ribs and at least two second reinforcing ribs are respectively arranged on opposite first side wall and second side wall of the main housing, both the first reinforcing ribs and the second reinforcing ribs extend into the main housing along the mounting opening, first limiting slots and second limiting slots are provided in two sides of the waterway board component or/and the bracket component, the first limiting slots are clamped to the first reinforcing ribs, and the second limiting slots are clamped to the second reinforcing ribs.

2. The water purifier according to claim 1, wherein the waterway board component closes the mounting opening, one surface of the waterway board component facing an inner cavity of the main housing is a waterway connection surface, one surface of the waterway board component facing away from the inner cavity of the main housing is an appearance surface exposed out of the mounting opening, the waterway connection surface is provided with a filter element plugging structure, one end of the first limiting slot and one end of the second limiting slot penetrate into the waterway connection surface, and the other end of the first limiting slot and the other end of the second limiting slot have a predetermined distance from the appearance surface.

3. The water purifier according to claim 2, wherein the waterway board component comprises a first cover plate and a second cover plate, one surface of the first cover plate and one surface of the second cover plate are fixedly connected towards each other to form a waterway chamber, the other surface of the first cover plate is the waterway connection surface, and the other surface of the second cover plate is the appearance surface, the appearance surface is flush with an edge of the mounting opening of the main housing, the first limiting slot and the second limiting slot are provided in the first cover plate, and the first limiting slot and the second limiting slot penetrates to the waterway connection surface from a surface of the first cover plate connected to the second cover plate.

4. The water purifier according to claim 1, wherein cross sections of both the first reinforcing rib and the second reinforcing rib are rectangle, dovetail shaped, L-shaped, or T-shaped, shapes of the cross sections of both the first limiting slot and the second limiting slot are matched with the shapes of the first reinforcing rib and the second reinforcing rib.

5. The water purifier according to claim 1, wherein bayonet slots are provided in one end of the first reinforcing rib close to the mounting opening and one end of the second reinforcing rib close to the mounting opening, the bayonet slots are arranged close to an inner side wall of the main housing, the waterway board component is provided with convex blocks at the first limiting slot and the second limiting slot, and the convex blocks are inserted into the bayonet slots.

6. The water purifier according to claim 1, wherein the bracket component is fixedly connected to the waterway board component; and/or, a bottom of the bracket component is connected to a third side wall of the main housing, a third reinforcing rib is arranged on the third side wall of the main housing, the bracket component is provided with a plurality of convex ribs, the convex ribs are connected to the third reinforcing rib in a staggered manner, or, a limiting slot is formed between two convex ribs, and the third reinforcing rib is clamped in the limiting slot.

7. The water purifier according to claim 6, wherein the bracket component is provided with a plurality of convex ribs, a third limiting slot is formed between two convex ribs, and/or, bayonet slots are provided in one end of the third limiting slot close to the mounting opening, the bayonet slots are arranged close to an inner side wall of the main housing, the waterway board component is provided with convex blocks at the third limiting slot, and the convex blocks are inserted into the bayonet slots.

8. The water purifier according to claim 1, wherein a fourth limiting slot is provided in a top of the waterway board component, a fourth reinforcing rib is arranged on a fourth side wall of the main housing, the fourth reinforcing rib extends into the main housing along the mounting opening, and is clamped in the fourth limiting slot.

9. The water purifier according to claim 2, wherein the main housing has a filter element mounting side, the filter element mounting side is provided with a filter element mounting hole for the filter element component to be inserted into a filter element plugging structure, a main lining plate is integrally arranged in the filter element mounting hole, and the main lining plate extends from an edge of the filter element mounting hole to a direction of the filter element plugging structure, there is a predetermined distance between the main lining plate and the filter element plugging structure;
below the filter element plugging structure, the waterway connection surface is fixedly connected to an auxiliary lining plate, one end of the auxiliary lining plate is fixed to the waterway connection surface, while the other end abuts against an edge of the main lining plate, lining plate limiting slots are provided in the two sides of the auxiliary lining plate, and the lining plate limiting slots sleeves the first reinforcing rib and the second reinforcing rib.

10. The water purifier according to claim 9, wherein the auxiliary lining plate is cylindrical or semi-cylindrical, and a front end of the auxiliary lining plate is provided with a fitting portion for sticking to an outer circumference of an end of the main lining plate.
